(19) United States
(12) Patent Application Publication
(10) Pub. No.: US 2004/0223836 A1
(43) Pub. Date: Nov. 11, 2004

(54) Vehicle ramp assembly

(76) Inventor: Ronald I. Robertson, Petal, MS (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/430,009

(22) Filed: May 6, 2003

(51) Int. Cl. B60P 1/00

(52) U.S. Cl. 414/537

(57) ABSTRACT

A vehicle ramp assembly for loading ATVs and like things onto transporting vehicles. The ramp assembly includes a pair of ramps positioned side-by-side. Each of the ramps has an upper end for engagement with a transporting vehicle and a lower end for positioning upon the ground. At least one crosspiece connects the ramps together between the upper and lower ends thereof. The crosspiece is releasably fastened to one of the ramps and is pivotally fastened to the other one of the ramps for compact storage.

### FIELD OF THE INVENTION

The present invention relates generally to material and article handling apparatus and, more particularly, to vehicle-loading skidways.

### BACKGROUND OF THE INVENTION

Due to their large size and substantial weight, loading all-terrain vehicles (ATVs) onto pickup trucks and trailers for transport has never been an easy task. Recently, some individuals have proposed collapsible ramps for elevating an ATV from the ground onto the bed of a truck or trailer. None of these ramps has seen widespread use or commercial success since they do not collapse very compactly and they often lack provisions to prevent their own shifting under load. Thus, the known, collapsible ramps often hinder the use of a truck or trailer during their deployment and pose a serious risk to life, limb, and property.

### SUMMARY OF THE INVENTION

In light of the problems associated with the known cargo-loading ramps that are meant to collapse when not in use, it is a principal object of the invention to provide a vehicle ramp assembly that is particularly helpful in moving ATVs and other wheeled vehicles to, and from, trucks, trailers, etc. The preferred ramp assembly collapses into a compact configuration when not in use and opens into a sturdy and unitary platform that cannot be tipped over when placed under load.

It is another object of the invention to provide a vehicle ramp assembly of the type described that can be adjusted in terms of width to accommodate ATVs of different make and model. Adjustment can be accomplished with a minimum of tools and training. Thus, it is believed that the vehicle ramp assembly of the present invention is intuitive to use.

It is an object of the invention to provide improved elements and arrangements thereof in a vehicle ramp assembly the purposes described which is lightweight in construction, portable, inexpensive to manufacture, and fully dependable in use.

Briefly, the ramp assembly in accordance with this invention achieves the intended objects by featuring a pair of ramps positioned side-by-side. Each of the ramps has a pair of side rails with C-shaped cross-sectional configurations that define inwardly opening channels along their lengths. A number of spaced apart rungs connect the side rails together. The rungs have opposed ends that are pivotally joined to the side rails and are positioned within the channels of the side rails. A pair of retaining flanges is pivotally fastened to the upper end of each of the ramps for snug engagement with a vehicle tailgate or other elevated surface. A pair of crosspieces connects the ramps together. Each of the crosspieces is releasably fastened to one of the ramps and is pivotally fastened to the other one of the ramps. Each of the crosspieces includes a pair of nested tubes whose positions relative to one another can be selectively fixed to adjust the spacing between the ramps.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a vehicle ramp assembly in accordance with the present invention shown attached to the rear portion of a pickup truck.

FIG. 2 is an enlarged portion of the vehicle ramp assembly of FIG. 1 with portions broken away to reveal details thereof.

FIG. 3 is a top view of the vehicle ramp assembly in an open configuration (shown by solid lines) for loading a vehicle and in a partially collapsed configuration (shown by broken lines).

FIG. 4 is a top view of the vehicle ramp assembly in a fully collapsed orientation for storage.

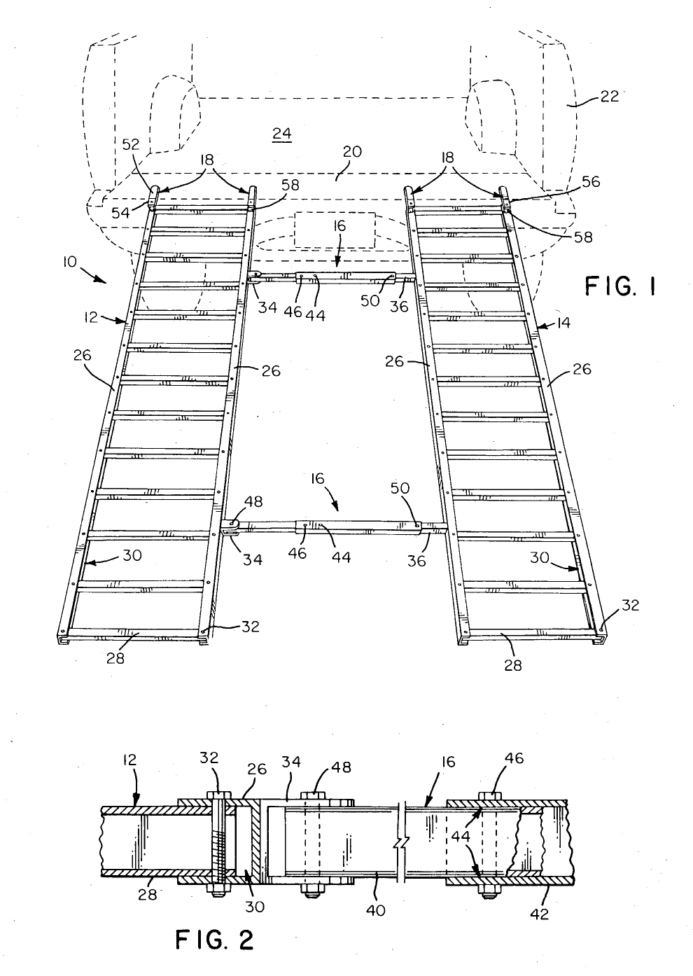

Similar reference characters denote corresponding features consistently throughout the accompanying drawings.

### DETAILED DESCRIPTION OF THE PREFERRED EMBODIMENT

Referring now to the FIGS., a vehicle ramp assembly in accordance with the present invention is shown at 10. Ramp assembly 10 includes a pair of ramps 12 and 14 connected together in a side-by-side fashion by a pair of crosspieces 16. The upper ends of ramps 12 and 14 are each provided with a pair of retaining flanges 18 for engagement with the reclining tailgate 20 of a pickup truck 22 and the lower ends of ramps 12 and 14 are adapted for positioning upon the ground. In use, an ATV (not shown) is driven from a position upon the ground, up ramps 12 and 14, across tailgate 20, and onto the bed 24 of pickup truck 22. Crosspieces 16 prevent ramps 12 and 14 from sliding laterally so as to inadvertently disengage from tailgate 20 while the ATV is on ramps 12 and 14.

Each ramp 12 and 14 includes a pair of side rails 26 connected together by a plurality of rungs 28. As shown, each side rail 26 has C-shaped cross-sectional configuration that defines an inwardly opening channel 30 along its length. Pivot pins 32, illustrated as nut and bolt combinations, secure the opposite ends of each rung 28 within the channels 30 of side rails 26. Pins 32 permit a 180° range of pivoting motion of rungs 28 relative to side rails 26 thereby permitting the side rails 26 of each ramp 12 and 14 to be brought into engagement with one another for compact storage and transport of ramps 12 and 14 when not in use.

Each crosspiece 16 includes a pair of nested, square tubes 40 and 42. Tubes 40 and 42 have a plurality of transverse apertures 44 that can be selectively axially aligned to receive a locking pin 46 to fix the positions of tubes 40 and 42 relative to one another. Thus, by selectively telescoping tubes 40 and 42, the length of each crosspiece 16 can be adjusted to position ramps 12 and 14 so as to accommodate ATVs of different wheel spacing.

Anchor portions 34 and 36 join crosspieces 16 to ramps 12 and 14. Preferably, each anchor portion 34 is a C-shaped bracket attached to the inner, side rail 26 of ramp 12. Each anchor portion 36, however, comprises a post attached to the inner, side rail 26 of ramp 14. A pivot pin 48 joins the outer end of tube 40 within anchor portion 34 and an anchor pin 50 secures anchor portion 36 within the outer end of tube 42. When not in use, crosspieces 16 may be swung on pivot pins 48 to a storage position adjacent the inner, side rail 26 of ramp 12.

Retaining flanges 18 comprise inner and outer parts 52 and 54 that are angularly attached to one another so as to form a shallow, inverted “V”. The inner part 52 of each retaining flange 18 is secured by means of a pivot pin 56 to one crosspiece 26. The outer part 54 is angled downwardly so as to engage tailgate 20 in a flush manner. A spacer 58 is positioned on each pin 56 between a side rail 26 and a retaining flange 18 to permit each flange 18 to easily pivot on a pin 56 and not bind against a side rail 26.

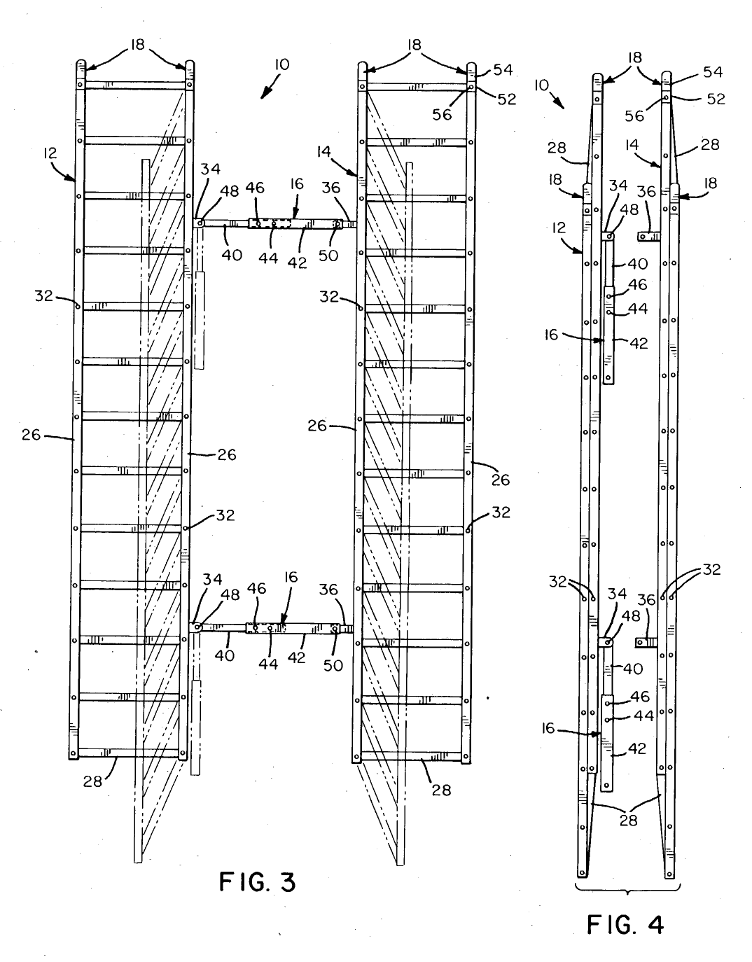

From the foregoing, it should be appreciated that use of ramp assembly 10 is straightforward. Starting with ramp assembly 10 in a fully collapsed state as shown in FIG. 4, ramps 12 and 14 are each opened for use by manually pulling their respective side rails 26 away from one another. (Such pulling advances side rails 26 through the broken line positions of FIG. 3 to the solid line positions of FIG. 3.) Next, flanges 18 of ramps 12 and 14 are rested upon lowered tailgate 20. Then, ramps 12 and 14 are connected together by moving crosspieces 16 from their storage positions parallel to side rails 26 to their open positions at right angles to side rails 26. After inserting anchor portions 36 into tubes 42 of crosspieces 16, anchor pins 50 are extended through anchor portions 36 and tubes 42 to lock such together. Now, an ATV or other vehicle with wheels having a diameter greater than the distance between rungs 28 can be motored up ramps 12 and 14 and onto bed 24 of pickup truck 22.

When the use of ramp assembly 10 is no longer required, it can be collapsed by simply reversing the steps outlined in the previous paragraph. The collapsed ramp assembly 10 can be easily stored and transported on bed 24 of pickup truck 22 in a collapsed condition. Thus, ramp assembly 10 can be transported and used practically anywhere.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

I claim:

1. A vehicle ramp assembly, comprising:
a pair of ramps positioned side-by-side, each of said ramps having an upper end and a lower end; and,
at least one crosspiece connecting said ramps together between said upper and lower ends thereof, and said crosspiece being releasably fastened to one of said ramps and being pivotally fastened to the other one of said ramps.

2. The vehicle ramp assembly according to claim 1 wherein each of said ramps comprises:
a pair of side rails, each having C-shaped cross-sectional configuration defining an inwardly opening channel along its length;
a plurality of spaced apart rungs connecting said side rails together, said rungs having opposed ends being pivotally joined to said side rails and being positioned within said channels of said side rails.

3. The vehicle ramp assembly according to claim 1 wherein said crosspiece comprises:
a pair of nested tubes each of which having a plurality of transverse apertures that can be selectively axially aligned; and,
a locking pin for positioning in said transverse apertures for fixing the positions of said tubes relative to one another.

4. The vehicle ramp assembly according to claim 1 further comprising a pair of retaining flanges pivotally fastened to said upper end of each of said ramps for engagement with a vehicle.

5. A vehicle ramp assembly, comprising:
a pair of ramps positioned side-by-side, each of said ramps having an upper end for engagement with a vehicle and a lower end for positioning upon the ground, each of said ramps including:
a pair of side rails, each having C-shaped cross-sectional configuration defining an inwardly opening channel along its length; and,
a plurality of spaced apart rungs connecting said side rails together, said rungs having opposed ends being pivotally joined to said side rails and being positioned within said channels of said side rails; and,
a pair of crosspieces connecting said ramps together between said upper and lower ends thereof, each of said crosspieces being releasably fastened to one of said ramps and being pivotally fastened to the other one of said ramps.

6. The vehicle ramp assembly according to claim 5 wherein each of said crosspieces comprises:
a pair of nested tubes each of which having a plurality of transverse apertures that can be selectively axially aligned; and,
a locking pin for positioning in said transverse apertures for fixing the positions of said tubes relative to one another.

7. A vehicle ramp assembly, comprising:
a pair of ramps positioned side-by-side, each of said ramps having an upper end and a lower end, each of said ramps including:
a pair of side rails, each having C-shaped cross-sectional configuration defining an inwardly opening channel along its length; and,
a plurality of spaced apart rungs connecting said side rails together, said rungs having opposed ends being pivotally joined to said side rails and being positioned within said channels of said side rails;
a pair of retaining flanges pivotally fastened to said upper end of each of said ramps for engagement with a tailgate; and,
a pair of crosspieces connecting said ramps together between said upper and lower ends thereof, each of said crosspieces being releasably fastened to one of said ramps and being pivotally fastened to the other one of said ramps, and each of said crosspieces includes a pair of nested tubes whose positions relative to one another can be selectively fixed.
